(19) United States
(12) Patent Application Publication
(10) Pub. No.: US 2014/0172510 A1
(43) Pub. Date: Jun. 19, 2014

(54) Enterprise Content Management (ECM) Solutions Tool and Method

(71) Applicant: HYLAND SOFTWARE, INC., Westlake, OH (US)

(72) Inventors: Mark Davis, Avon Lake, OH (US); Michael D. Discenzo, Westlake, OH (US)

(73) Assignee: HYLAND SOFTWARE, INC., Westlake, OH (US)

(21) Appl. No.: 13/717,861

(22) Filed: Dec. 18, 2012

(51) Int. Cl. G06Q 10/06

(52) U.S. Cl. CPC G06Q 10/0637
USPC 705/7.36

(57) ABSTRACT

A computer-implemented tool provides enterprise content management solution information. The computer-implemented tool includes: a set of templates stored in computer-implemented data storage, each template corresponding to an industry group, and including a set of organization segments, sub-segments, or both, and a set of enterprise content management solutions. A processor is configured to determine a first template associated with an identified organization from the set of templates and to determine enterprise content management organization information associated with the identified organization. The processor is also configured to generate a quantitative indicator based on the set of enterprise content management solutions implemented by the identified organization in the industry group, the organization segment, or the organization sub-segment, in comparison to the set of the enterprise content management solutions associated with the respective industry group, organization segment, or the organization sub-segment. The processor is configured to transmit display data.

### FIELD

This disclosure relates to enterprise content management (ECM) systems and electronic methods for providing the same.

### BACKGROUND

Historically, software and technical consulting firms have relied on being the sole source of expertise and knowledge in a field, often relying on customer's unfamiliarity with technology and developments in the field. While this business model traditionally has been widely successful in the ECM field, today's customers are becoming more educated and technically savvy. While an ECM provider's expert opinion on a particular project along with a cost quote is still valued, with a greater number of ECM customers being charged with making informed, lowest-dollar decisions, a greater number of organizations are mandating that appropriate research be completed prior to any purchasing. The expert opinion of an ECM provider is often no longer considered to be the end of the decision-making process.

It can be difficult for an organization's decision-maker to understand all the options available to them, especially when those options extend across several areas of the organization in which the lead decision maker may not be familiar. Research as to what ECM solutions are available to an organization and which ones are preferred is hampered by the speed at which industries and offered products evolve.

Furthermore, the ECM field is also somewhat unique in that it touches or has the potential to affect nearly all industry groups, and nearly all segments of an organization in an industry group. This makes effective evaluation and comparison even more difficult for an organization's decision-maker, as it is difficult to understand all the factors and needs in each segment of an organization.

### SUMMARY

A computer-implemented tool is described herein for providing enterprise content management solution information. The computer-implemented tool includes: a set of templates stored in computer-implemented data storage, each template corresponding to an industry group. A first template of the set of templates includes a set of organization segments, a set of organization sub-segments, or both, each of which correspond to the industry group, and a set of enterprise content management solutions.

The enterprise content management solutions are electronically associated with one or more of: an organization segment from the set of organization segments, an organization sub-segment from a set of organization sub-segments, and an organization identifier for an organization that has implemented or is implementing the enterprise content management solution.

The enterprise content management organization information is stored in computer-implemented data storage associated with the organization identifier. The enterprise content management organization information includes enterprise content management implementation information that indicates a set of enterprise content management solutions already implemented or in the process of being implemented by the organization.

A processor is configured to identify an organization based on received organization identifier input, thereby producing an identified organization, and to determine a first template associated with the identified organization from the set of templates and to determine the enterprise content management organization information associated with the identified organization. The enterprise content management organization information includes the enterprise content management implementation information.

The processor is also configured to generate a quantitative indicator based on the set of the enterprise content management solutions and the enterprise content management implementation information. The quantitative indicator indicates the set of enterprise content management solutions already implemented or in the process of being implemented by the identified organization in the industry group, the organization segment, or the organization sub-segment, in comparison to the set of the enterprise content management solutions associated with the respective industry group, organization segment, or the organization sub-segment.

The processor is configured to transmit display data, the display data comprising the set of organization segments, organization sub-segments, or both, that are associated with the first template, the set of enterprise content management solutions associated with the first template, and the quantitative indicator.

In another embodiment, a computer-implemented graphical user interface provides enterprise content management solution information to an identified organization on an electronic visual display. The graphical user interface includes: a set of organization segment fields, each organization segment field listing an organization segment title, the organization field segments based on an industry group template; a set of organization sub-segment fields or enterprise content management solution fields associated with respective organization segment fields; a first organization sub-segment field or a first enterprise content management solution field comprising a listing of organization sub-segment titles, enterprise content management solution titles, or both.

In the graphical user interface, one or more of an industry group field, the first organization segment field, or the first organization sub-segment field, include a quantitative indicator of the set of enterprise content management solutions already implemented or in the process of being implemented by the identified organization in the industry group, the organization segment, or the organization sub-segment, in comparison to the set of the enterprise content management solutions associated with the respective industry group, organization segment, or the organization sub-segment.

In another embodiment, a computer-implemented method includes: electronically receiving organization identifier input, identifying an organization from the organization identifier input, and producing an identified organization. Then steps are included for: determining a first template associated with the identified organization from a set of templates, the first template comprising a set of organization segments, a set of organization sub-segments, or both, and a set of enterprise content management solutions associated with an industry group; determining enterprise content management organization information associated with the identified organization, the enterprise content management organization information includes enterprise content management implementation information that is a set of enterprise content management solutions already implemented or in the process of being implemented by the identified organization; generating a quantitative indicator based on the set of the enterprise content management solutions and the enterprise content management implementation information, the quantitative indicator indicating the set of enterprise content management solutions already implemented or in the process of being implemented by the identified organization in the industry group, the organization segment, or the organization sub-segment, in comparison to the set of the enterprise content management solutions associated with the respective industry group, organization segment, or the organization sub-segment; transmitting display data for displaying the set of organization segments, organization sub-segments, or both, the set of enterprise content management solutions, and the quantitative indicator.

The articles “a,” “an,” and “the” should be interpreted to mean “one or more” unless the context clearly indicates the contrary.

The term “set” as used herein, should be interpreted to mean a set with at least one member, and not an empty set, unless the context clearly indicates the contrary.

The term “visually associated” means that a display shows an association between one or more elements by proximity or through another graphical item. Elements that are visually associated may, for example, include items being displayed closely together, displayed with a common color, displayed in a common box or outline, displayed in adjacent cells, or displayed with a line or lines connecting them.

The term “electronically associated” includes elements stored together in data storage or an element associated through an electronic link to another element in data storage. Elements that are electronically associated may also be visually associated and vice-versa.

### BRIEF DESCRIPTION OF THE DRAWINGS

FIG. 1 is a schematic of an example system for implementing the ECM tool.

FIG. 2 is an example of a basic graphical representation of information contained in a first example template.

FIG. 3 is an example flow chart depicting an example method of operation of the example ECM tool.

FIG. 4 is an example flow chart representing an example process for receiving and processing user-generated ECM solution feedback information for ECM collaborative information.

FIG. 5 is a view of an example computer-implemented graphical user interface 1000 for providing enterprise content management solution information to an organization.

FIG. 6 is a view of an example graphical user interface 1000 for providing further information on ECM solutions in an organization segment or sub-segment.

FIG. 7 is a view of an example graphical user interface 1000 with an ECM solution detailed information window 1100.

FIG. 8 is a schematic of an example computing device for use in the methods and systems described herein.

### DETAILED DESCRIPTION

Disclosed herein is a computer-implemented tool with which organizations can investigate unique historical and timely similar organization information, thereby allowing them to do their own research of available ECM solutions. The tool also operates to provide a way to visualize available solutions across multiple areas of an organization that may be especially helpful to a high-level decision-maker who may not be thoroughly familiar with all aspects of the organization. The tool also benefits the ECM provider by providing opportunities for further interaction with clients and further exposure of services they offer.

Enterprise content management (ECM) is the strategies, methods and tools used to capture, manage, store, preserve, and deliver content and documents related to an organization. Organization as used herein means a company, organization, business, non-profit, charitable, or other group conducting operations.

ECM includes the following sub-categories: web content management, collaborative content management, and transactional content management.

Web content includes information or documents resident on internet or cloud-based servers. ECM in the web content management field includes management of websites and databases as well allowing several content producers the ability to create and publish content (articles, photo galleries and so forth). An ECM solution in this area may allow for dynamic uploading and editing of content.

Collaborative content includes documents or other content that multiple users have or need access to. An ECM solution is enabled to be accessed and edited by multiple users simultaneously. For example, an entire team can work from the same master document, tracking changes, saving minor drafts and embedding files.

Transaction content includes a collection of physical documents that may be turned into electronically-, magnetically-, or optically-stored documents. For example, an organization may have a lot of physical documents, such as, insurance claims, medical records, government forms, payroll, student admissions, etc. An ECM solution in this area ideally provides an efficient way to maintain and access those documents and may provide automated and repeatable business processes and integration with other business applications.

ECM solutions allow the management of an organization's unstructured information. In an embodiment, ECM solutions are computer-implemented solutions involving electronic, magnetic, or optically stored media or information. In an example, the ECM solution includes software that is associated with, interacts with, or otherwise manages an organization's stored content. In another example, an ECM solution may encompass software, or both software and hardware components. In an embodiment, an ECM solution includes software that a human interacts with and is not just firmware that resides on an apparatus.

A computer-implemented tool for providing ECM solution information is disclosed. This tool allows an organization to have transparent access to their existing ECM solution set within their organization. Additionally, it affords organizations a visualization of a larger suite of relevant solution offerings that will allow decision-makers in the organization to take an active role in evaluating and optimizing ECM throughout their organization and to investigate what similar organizations in their industry group are doing in the ECM area.

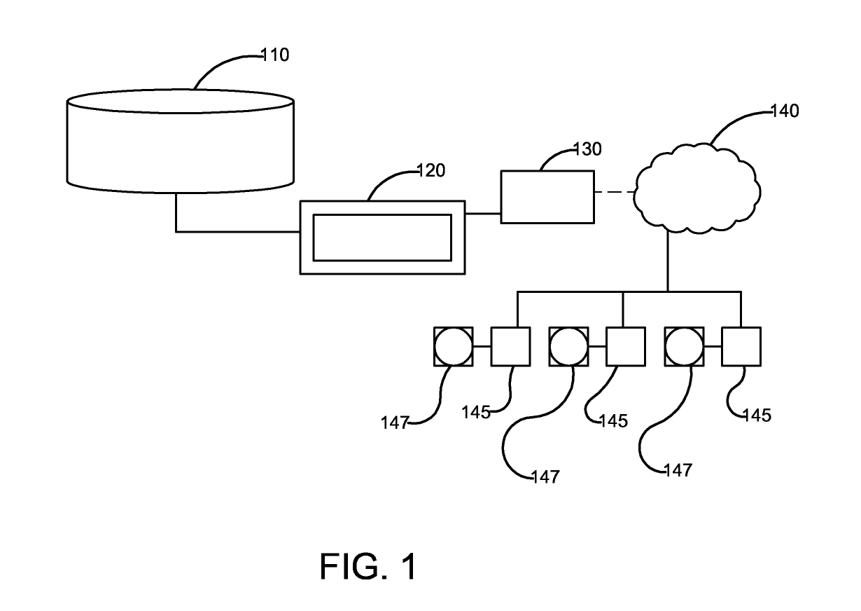

In an example shown in FIG. 1, a computer-implemented tool 101 for providing enterprise content management solution information is implemented in a computer-implemented system, the system including a data storage 110, a processor 120, and a server 130.

In an example, the data storage 110 is a data repository or a set of data repositories, which may, for example, be stored as a MySQL database or set of databases.

In an example, at a basic level, the data storage 110 stores information comprising a set of industry group associated templates that comprise a set of ECM solutions selected to be pertinent to the industry groups associated with the templates along with ECM solution detailed information associated with the ECM solutions (explained in detail below). The data storage 110 also stores a set of organization identifiers for organizations that are registered users of the ECM tool, and ECM organization information that includes ECM information that is specific to individual organizations. In an example, the information stored in the data storage 110 is encrypted.

The processor 120 is in communication with, such as being electronically coupled to, the data storage 110, and, if, for example, a set of data repositories are utilized, the processor 120 is in communication with, such as being electronically coupled to, each data repository. The term processor should be construed broadly as it is not meant to be limited to a single processor if multiple processors could perform the same function. As used herein, “electronic” coupling, transmission, or receiving includes electric, optic, and all electromagnetic means of coupling and communication.

The server 130 is in communication with, such as being electronically coupled to the processor 120, and is configured to communicate with the processor 120 and to communicate data electronically to other computing devices 145 over a network 140, such as, a LAN, WAN, or the Internet 140. For example, the server may be an APACHE web server. In an example, the server 130 transmits and/or receives encrypted data and/or facilitates encryption of data on the user's computing device 145 by communicating encrypted data and utilizing key, session information, and/or cookies.

In an example, the computer devices 145 in communication with the network 140 are in communication with, such as electronically coupled to an electronic visual display 147 such as, for example, a computer-linked monitor or television, such as a CRT, LED, or plasma monitor. The display data is displayed as a graphical user interface (discussed in depth below) on an electronic visual display.

In an embodiment, the processor 120 is included in the server 130. In such an embodiment, communications between the server 130 and processor 120 referred to herein should be interpreted as being communications through the system bus 1106 discussed below.

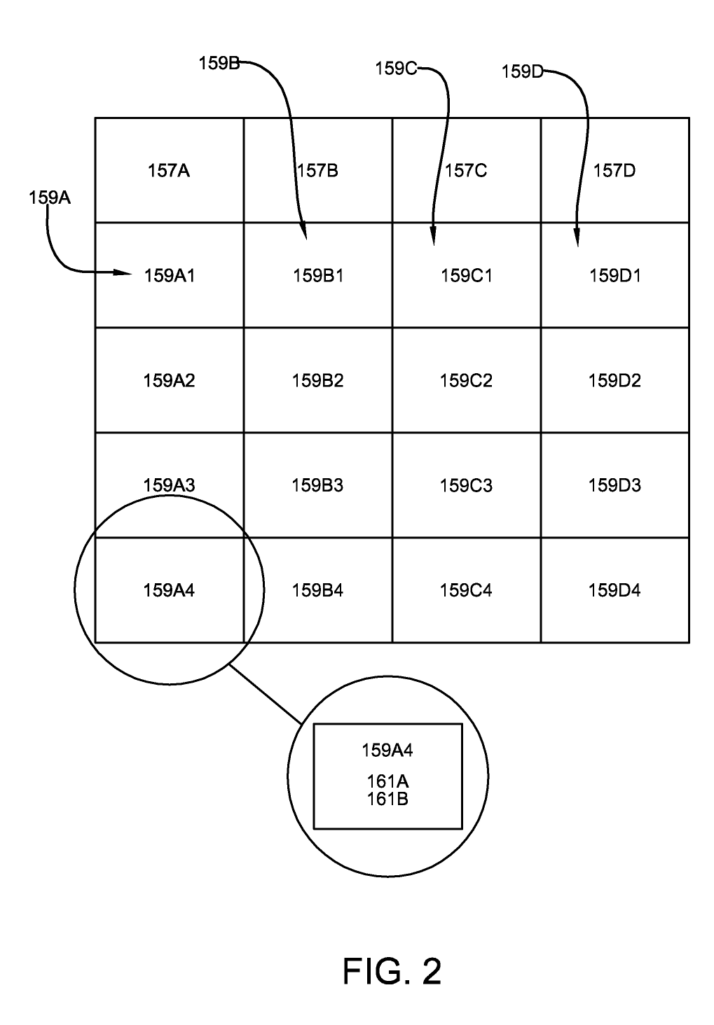

FIG. 2 is an example of a basic graphical representation of information contained in a first example template 151. The first example template 151 includes a set of organization segments 157A-D corresponding to an industry group and sets of organization sub-segments 159A-159D corresponding to the organization segments 157A-D in the respective column and/or the industry group. A set of ECM solutions 161 are part of the template 151 as well, and are associated with one or more members of the set of organization segments 157A-D and one or more members of the sets of sub-segments 159A-D. For example the magnified view shows an example first organization sub-segment 159A4 with the ECM solutions 161A, 161B associated with it.

The tabular grid view of FIG. 2 shows an example of how the data in each cell corresponds to other data. In other examples, the template information may be stored in non-tabular formats, e.g. a comma separated value format. The correspondence between portions of the data as shown in the FIG. 2 view may be the same, even if data is stored in a non-tabular format. Moreover, as shown in FIG. 2 each organization segment 157A-D is associated with the industry group (because they are in the industry group table), and each organization segment 157A-D is associated with a set of organization sub-segments 159A-D (because they are in the same column) and vice versa. ECM solutions 161 are associated, most specifically, with an organization sub-segment 159A-D, and are also associated with the respective organization segment 157A-D and industry group as a whole and vice-versa.

As explained in more detail below, the set of templates 151, organization identifiers and ECM organization information that are stored in computer-readable data storage are processed by the processor 120 to generate display data that is transmitted by a processor to identified organizations. The display data includes graphical information that allows a decision-maker to quickly view quantitative indicators of how their organization is optimizing its operations through ECM, and obtain comparative and collaborative information from other users in the industry.

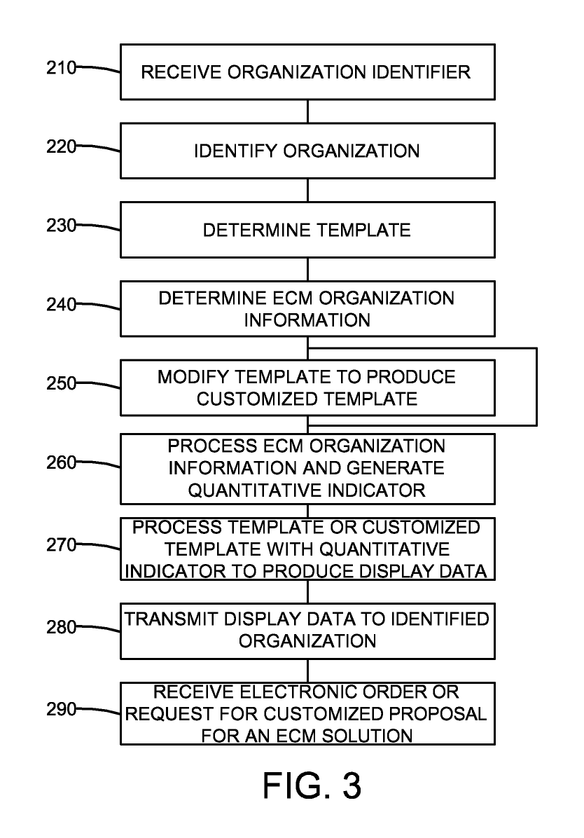

FIG. 3 is a flow chart depicting an example method of operation of the example ECM tool. In an initial login procedure, the server electronically receives an organization identifier 210. In this example, the organization identifier is transmitted from a computer operated by an organization's user over the internet and received by the server. The server is in communication with a processor controlled by the ECM provider.

In this example, the processor matches the organization identifier with a list of organization names, thereby identifying the organization 220 as one that is recognized and/or registered with the ECM tool. The processor may also authenticate the user of the organization or this authentication may be done based on instructions in local data storage at the organization's computer.

In a further example step of the method, the processor is configured to execute instructions to determine a template 230. The template is stored in computer-readable data storage, for example, in a data repository as a database format. In an example, the processor determines the template by matching an identified organization to a corresponding first template. In another example, the processor determines the template directly based on the organization identifier. The processor could also first determine an industry group that the organization identifier corresponds too, and the template for the industry is the determined template. In each case however, the determination is based on the organization identifier input.

The templates stored in computer-readable data storage are based on an industry group. The industry group may be selected to include organizations that have similar ECM problems and/or solutions. For example, the following industry groups may each have separate templates: higher education, education, medical, insurance, real estate, legal, manufacturing, internet sales, small business, utility, state government, local government, federal government, judicial, police, fire and safety, and political. These are only a few examples of the industry templates, and many others could be available and stored in computer-readable data storage.

The templates include information designating a set of organization segments, sets of organization sub-segments, and a set of ECM solutions for each segment or sub-segment. In an example, one or more organization segments do not have associated organization sub-segments. The categories are generally segments of the organization that have separate functions, employees, and ECM needs.

As a general example, the organization segment is a business unit or an area of an organization that is functionally separate from other areas of the organization. An organization segment may include a department sub-segment. Specific ECM solutions may be associated with the organization segment and/or sub-segment. For a more specific example, in a higher education template, an organization segment is enrollment, and a sub-segment is graduate admission, and one of the specific ECM solutions associated with both of these is online application import.

In an example, the set of ECM solutions included in a template are those that the ECM provider has designated as most relevant to the industry. This could be determined based on what organizations are placed into the industry group and what solutions have been implemented in these organizations. Specific examples of ECM solutions in an education template and a student onboarding segment include computer-based methods for: electronic acknowledgement of student conduct policies, student housing requests, meal plan management, ordering student parking, online advisor scheduling, and online class scheduling.

In an example, the ECM solutions may be applicable for more than one template, such as if they have applicability to more than one industry. For example, a solution directed to electronic policy acknowledgement management may be applicable in the higher education industry as well as the medical industry. The ECM solution and associated ECM solution detailed information may be duplicated in each template or in another example the processor is operable to determine the ECM solutions in each template and access the ECM solution detailed information associated with the ECM solution, wherein the ECM solution detailed information is singly and separately stored, rather than being duplicated in each template in the data storage.

In an example, as a new ECM solution is implemented or offered by the ECM provider, a title and detailed information is generated and stored in one or more templates. Additionally, the titles of the ECM solutions and the contents of the ECM solution detailed information are key-worded by the ECM provider and this search information is stored and searchable in a computer-implemented search function provided to the organization user and ECM provider.

The ECM solutions presented in the template may also include user-initiated solutions. In an example, the proposed solution is implemented and is then added to the set of ECM solutions for the industry template associated with the organization that submitted the solution. In another example, the proposed solution could be added to the industry template even before implementation. In an example, the user submitting the proposed solution has the option of keeping the solution private, or only allowing a select group of other organizations to see the solution. In an example, these selections by the submitter are stored as privacy data as discussed above. In an example, the user submitted ECM solutions are initiated by a user submission to the ECM provider through a submission feature in the ECM tool.

In an example, each ECM solution includes ECM solution detailed information that provides further details on the ECM solution. In an example, the ECM solution detailed information includes a general definition of the solution, a general cost estimate for implementation of a solution, an estimate on the time to implement a solution. The general nature of the estimates is for informational and research purposes. For certain ECM solutions, a fixed price and/or time to implement the solution may be provided as part of the ECM solution detailed information. In an example, this option is available for solutions that are simple and/or have been routinely implemented by the provider.

In an example, the ECM solution detailed information includes a link, contact information, or other means for contacting the ECM provider regarding a particular selected ECM solution. In an example, the ECM user is provided with a feature enabling them to compile a set of ECM solutions and simultaneously electronically contact the ECM provider regarding ordering the set of solutions (for simple flat fee solutions) or contacting the ECM provider for a customized time and cost quote for the set of ECM solutions. This contact or ordering process is described in more detail below.

In an example, the ECM solution detailed information also includes ECM collaborative information that is generated by users of the tool. The ECM collaborative information includes: ECM solution feedback information received from a user of the ECM tool, which may or may not be revised by the ECM provider. The feedback information may include a ranking or rating system, such as a four star, or scale of 1 to 10 feedback option. In another embodiment, the feedback information includes an option for writing a text review. The process for receiving ECM solution feedback is also described in greater detail below.

The ECM collaborative information feature allows a decision-maker to not only review what other ECM solutions are available in the industry, but to actually review feedback from other users of the tool that have implemented or are in the process of implementing the solution. The decision-maker could also contact those organizations that are willing to be contacted from the contact information provided in the ECM solution detailed information. The contact information may be in the form of an e-mail address, a phone number, a fax number, or a mail-box or instant message application supported by the ECM tool itself.

In an example, privacy data stored in computer-readable data storage is associated with the ECM collaborative information and defines whether the user that generated the feedback has allowed the feedback and/or contact data to be shared globally or with only certain organizations.

For example, the privacy information may include a list of certain organizations or organization identifiers that are not authorized to receive the feedback and/or contact information. Alternatively, the privacy information may include a list of only organizations that are authorized to receive the feedback and/or contact information. In an example, the privacy data is associated with all collaborative information received from a user and is stored as ECM organization information. In another example, the privacy data is associated with the particular collaborative information received from the user on a particular ECM solution.

In an example, display format data that determines what format the information contained in the template is displayed in, is also included in the stored template. In another example, this format data is the same for all templates and may be stored separately in computer-readable data storage.

In another step of the example method, ECM organization information for the identified enterprise is determined by the processor 240. In an example, the ECM organization information is stored in a computer-readable data storage and is retrieved by the processor based on the organization identifier.

In an example, the ECM organization information includes: information about the size of the identified organization (as determined by revenue, industry ranking, or number of employees), industry operations of the organization, privacy data for solutions implemented by the organization, server or database infrastructure information, or information on an organization's information technology (IT) personnel. The ECM organization information also includes ECM implementation information, which identifies ECM solutions offered by the provider that have already been implemented and/or are in the process of being implemented by the identified organization. In an example, the ECM implementation information is the only ECM organization information.

In an optional example step, the template is modified to customize the template 250 based on the identified organization and the stored ECM organization information associated with the identified organization as determined by the processor. For example, in this step one or more of the categories, sub-categories, ECM solutions, or ECM solution detailed information of the template is modified based on the ECM organization information. The modification of this step produces a customized template. In this context the term “modification” includes modifying information in the template and/or adding or deleting information in the template.

For example, an estimated cost in the ECM solution detailed information is reduced because of the high skill level of an organization's internal IT personnel or because the servers or database structure had recently been optimized by the provider during implementation of a previous solution. In another example, the categories are customized for an organization that operates in more than one industry. In the example modification based on privacy data, the collaborative ECM information is modified to restrict information that is presented to certain organizations in an industry template, for example, if a close rival in the industry does not want to share information with a selected organization.

In another example step 260, the ECM implementation information for the identified organization is processed to determine what solutions have already been implemented by the organization, and to produce a quantitative indicator of the solutions that have been implemented already compared to the number of solutions that are available but have not yet been implemented.

In an example, the quantitative indicator is a processor-compiled set of ECM solutions already implemented or in the process of being implemented by the identified organization in the industry group, the organization segment, or the organization sub-segment, in comparison to the set of the ECM solutions associated with the respective industry group, organization segment, or the organization sub-segment. The quantitative indicator may be based on a ratio of the numerical count of the total available ECM solutions provided by the ECM provider and viewable in the tool in comparison to a numeric count of the ECM solutions implemented by the identified organization.

In an example, the quantitative indicator is a comparative value of the set of enterprise content management solutions already implemented or in the process of being implemented by the identified organization in comparison to the total set of ECM solutions available from the provider that are associated with the template. This overview quantitative indicator allows a decision-maker at the organization to quickly see how their organization's utilization of ECM solutions compares with the total solutions that are provided in the industry group. The format data may indicate that the segment indicator is displayed in proximity to the industry group or template title or in the background of a field showing the industry group or template title.

Another example that may be used alone or in conjunction with the overall quantitative indicator is a segment quantitative indicator. In this example, the segment quantitative indicator represents the ratio of the ECM solutions already implemented or in the process of being implemented in a segment of the template by the identified organization compared to all ECM solutions associated with the segment in the template. The format data may indicate that the segment indicator is displayed in proximity to the segment title or in the background of a cell or field showing the segment title.

Another example that may be used alone or in conjunction with the overall quantitative indicator and/or the segment quantitative indicator is a sub-segment quantitative indicator. In this example, the sub-segment quantitative indicator represents the ratio of the ECM solutions already implemented or in the process of being implemented in a sub-segment of the template by the identified organization compared to all ECM solutions associated with the sub-segment of the template. The format data may indicate that the sub-segment indicator is displayed in proximity to the sub-segment title or in the background of a cell or field showing the sub-segment title.

In another example, any or all of the above indicators may comprise a ratio of the organization's implemented solutions compared to the average number of utilized solutions in the industry group. This indicator would provide an illustration of how the organization compares to other organizations in the industry. In an example, this quantitative indicator may selectively be displayed to only identified organizations that have an ECM solution implementation that is below the industry average in one or more of the total industry group, segment, or sub-segment.

In a further step in the example method, the processor processes the template or customized template including the format data and the quantitative indicator to produce display data 270.

Additional, global features that are independent of the template may also be provided in the compiled display data, such as, for example an instant message, e-mail, or other communication link to the ECM provider's customer service department. In an example, the display data may present an option for electronically submitting feedback for a set of the ECM solutions provided in the template. This may be included in the global data or as part of the template, and may be customized based on the organization identifier to only allow a user to provide feedback on ECM solutions they that have implemented and/or are implementing. In another example this information may be part of each of template.

In a further step of the example method, the display data is received by the server and transmitted to the identified organization 280 for display. In an example, the display data includes the template formatted as determined in the format data, and includes at least the following: a set of organization segments, (optionally a set of respective organization sub-segments), the set of ECM solutions (at least the titles the ECM solutions), and a quantitative indicator of the set of enterprise content management solutions already implemented or in the process of being implemented by the identified organization in the industry group, the organization segment, or the organization sub-segment, in comparison to the set of the enterprise content management solutions associated with the respective industry group, organization segment, or the organization sub-segment. In another example, the display data includes the ECM solution detailed information, the ECM collaborative information, or portions thereof.

In an example, the display data may include information that is not transmitted at the same time or displayed at the same time. For example, the ECM solution titles and ECM solution detailed information may not be transmitted or displayed until the user requests further detail on an organization segment or sub-segment field. In an example, the step of transmitting display data is not a single transmission but a series of transmissions transmitted at intervals in response to electronic requests, such as a click on a display field, received from the user.

In an additional example step of the method, the server receives an electronic order or request for a customized proposal 290 for an ECM solution or set of ECM solutions from a user of the ECM tool. For example, the electronic order or request may be received in response to the user selecting an interactive communication link presented in the transmitted display data associated with an ECM solution presented in the display data.

In an example where the associated ECM solution has a fixed price, the electronic communication to the server is a direct order from the customer to implement the ECM solution. In an example where the associated ECM solution has only a general cost estimate provided in the ECM solution detailed information, the electronic communication is a request to the ECM provider to reply with a customized cost and/or time quote for providing the ECM solution.

In an example the ECM provider responds to the request or order with an electronic communication through the ECM tool, such as an on-screen notification, a message sent to an inbox in the tool, or through avenues outside of the tool such as a phone call or e-mail.

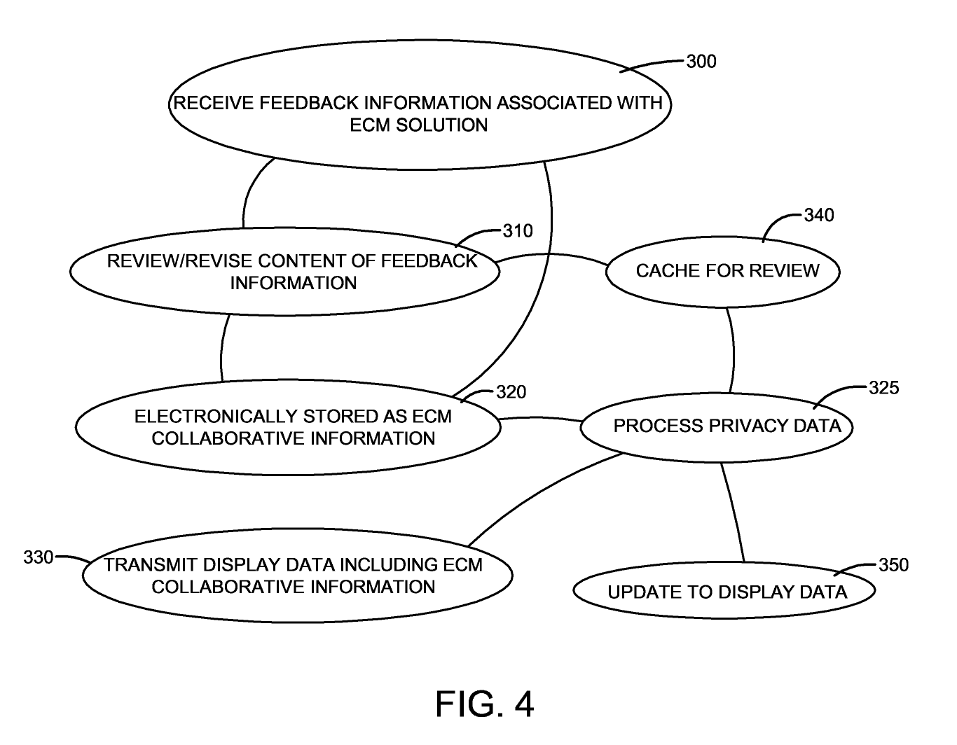

FIG. 4 is a flow chart representing an example process for receiving and processing user-generated ECM solution feedback information for ECM collaborative information.

In a step of the example process of FIG. 4, the server receives user-generated ECM feedback information associated with an ECM solution 300. In an example, as mentioned above, the display data may present an option for electronically submitting the feedback information through the ECM tool. The user may select the option, fill-in, and transmit the ECM feedback information electronically to the server.

The user ECM solution feedback information may include, for example, comments on a user's experience with the effectiveness of the solution or the cost, time, or scheduling issues of the solution, contact information of the user, and/or privacy data. The privacy data indicates a set of organizations that the organization providing ECM feedback information is willing or unwilling to share the feedback information with.

In an example step, the ECM user feedback is reviewed by the ECM provider for content and accuracy, and revised if appropriate 310. This step may include organizing the feedback information and generating and storing keyword data in computer-readable data storage order to enable the searching, sorting, and retrieval of this information by end users, administrators, and/or auditors.

After reviewing and/or revising, the feedback information or revised feedback information is stored in data storage as ECM collaborative information 320 where it is available for transmission as display data 330 to users of the ECM tool.

In another example, the feedback immediately becomes stored in computer-readable data storage as ECM collaborative information 320 for transmission as part of the display data 330.

In an alternative example, the received ECM feedback information is temporarily stored in a memory cache 340 and is posted in real-time or near real-time to users of the ECM tool as display data 330 as a pushed update to the display data 350. The ECM feedback in the cache may later be reviewed and revised for content 310 and be added to the ECM collaborative information 320 in the data storage for transmission as display data 330.

In each example of the process of FIG. 4, prior to transmitting the display data 330, the privacy data associated with the ECM solution or organization that submitted the ECM solution feedback information is processed 325. The processor removes any ECM solution feedback information from any display data to be transmitted to an organization identified not to receive it in the privacy data.

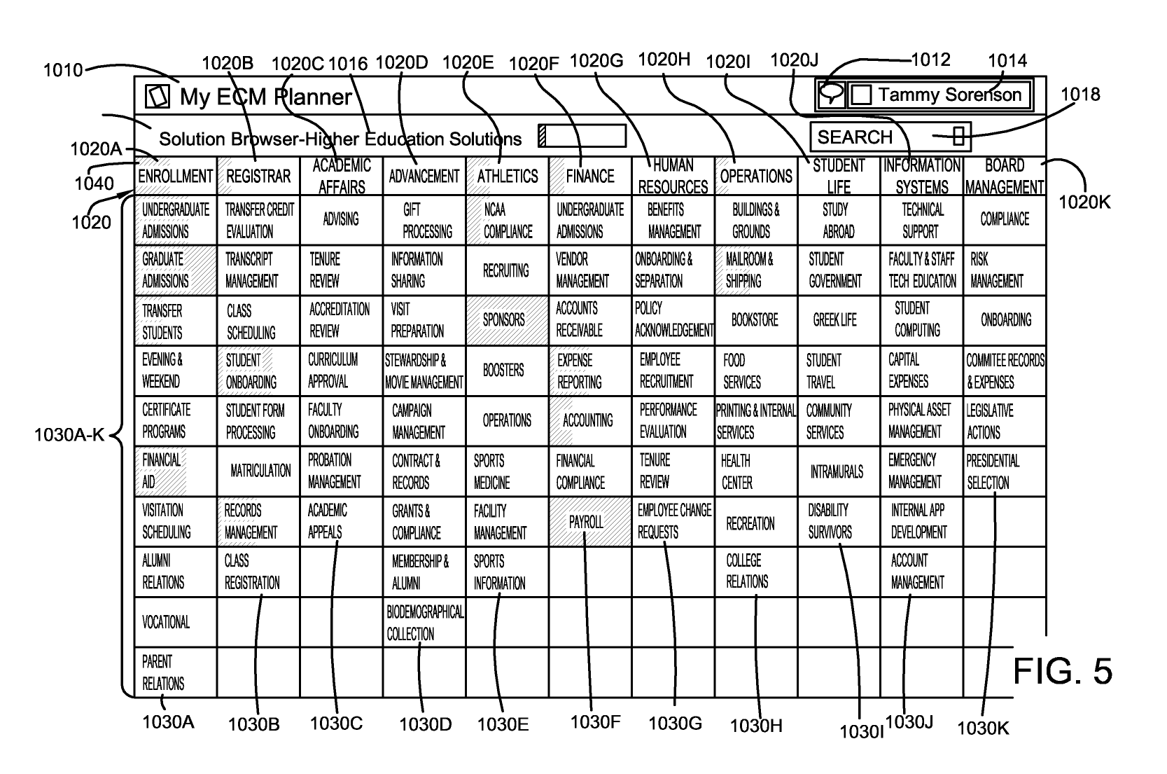

FIG. 5 depicts an example computer-implemented graphical user interface 1000 for providing enterprise content management solution information to an organization. It is also an example of a display showing the display data that includes format data and information from an example first template as discussed above. The graphical user interface 1000, for instance, can be rendered on a display screen (not shown) of a computing device (not shown). A first template depicted in this example is for the higher education industry group.

The example graphical user interface 1000 includes a title field 1010 located at the top of the interface and extending the majority of the width of the interface 1000.

In the upper right corner a communication icon field 1012 is located, wherein upon an interaction such as “clicking” by the user opens a communication feature, such as an instant message application connecting the user to the ECM provider's customer assistance department.

Also in the upper right corner of the interface 1000, an authorized user field 1014 displays the name of the logged-in authorized user of the ECM tool.

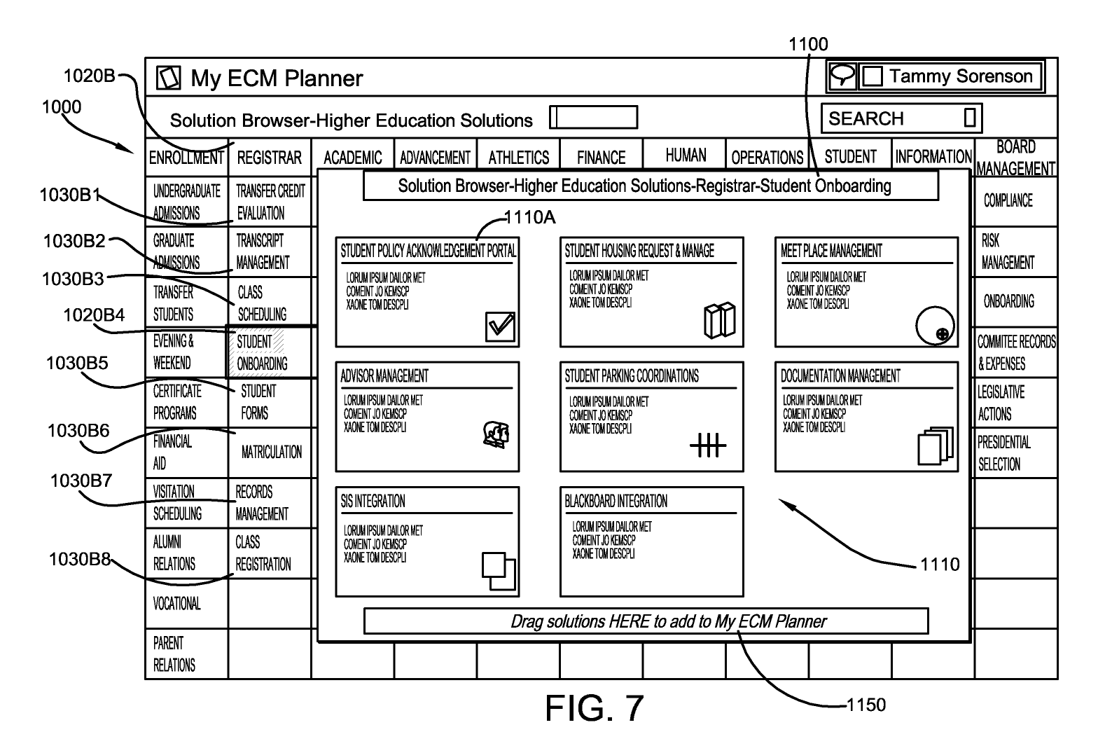

Beneath the communication icon field 1012 and the authorized user field 1014 is a search field 1018, where a user can enter search terms and ECM solutions are returned matching the search terms. In an example the results of the search may be returned as the ECM solution fields 1110, such as those depicted in FIG. 7 or links thereto. In an example, the user can enter another organization title and search for collaborative feedback or solutions submitted by that organization.

Beneath the title field 1010, an industry group field 1016 that corresponds to a first template is displayed. The title of the industry group, in this example, “Higher Education,” is displayed in this field 1016.

A set of organization segment fields 1020 spans across a width dimension of the interface 1000 defining the top row of a set of columns. Each organization segment field 1020A-K lists a title of an organization segment. The organization field segments 1020A-K and titles are associated with organization segments common in the higher education industry group.

Beneath the organization segment fields 1020A-K, the example interface 1000 comprises sets of organization sub-segment fields 1030A-K associated with the organization segment fields 1020A-K in the respective top row. The sets of organization sub-segment fields 1030A-K comprise cells with organization sub-segment titles that are associated with the segment title in the same column. In this example interface 1000 the organization segment fields 1020A-K each comprise the first row of a column, and the cells of the organization sub-segment fields 1030A-K comprise subsequent rows of the columns, thereby forming a grid with a plurality of columns corresponding to the organization segment fields 1020A-K and with a plurality of cells displaying the organization sub-segments titles.

For example, an example first organization segment field 1020A has the organization segment title “Enrollment.” In the cells beneath the segment field 1020A (or top row), the associated set of organization sub-segment fields 1030A are listed in cells with each cell displaying a title of the organization sub-segment. Organization sub-segment titles such as “Undergraduate Admissions,” “Graduate Admissions,” etc. are listed in the first set of organization sub-segment fields 1030A. Each cell of the first set of organization sub-segment fields is an organization sub-segment field.

In an alternative example, instead of the sets of organization sub-segment fields 1030A-K, sets of ECM solution fields are listed beneath one or more of the organization segment fields 1020A-K. The ECM solution fields comprise titles of the ECM solutions associated with the organization segment fields 1020A-K.

In another alternative example, sets of ECM solution titles are listed in the sets of organization sub-segment fields 1030A-K along with the titles of the organization sub-segments.

The example interface 1000 depicts the quantitative indicators (shown but not numbered) that have been discussed above. In the example interface 1000, each of the industry group field 1016, the organization segment fields 1020A-K, and the organization sub-segment fields of the sets of organization sub-segments fields 1030A-K, include a quantitative indicator of the set of enterprise content management solutions already implemented or being implemented by the identified organization in the respective industry group, the organization segment, or the organization sub-segment, in comparison to the set of the enterprise content management solutions associated with the respective industry group, organization segment, or the organization sub-segment.

In alternative example the industry group field includes a quantitative indicator of the set of ECM solutions already implemented or in the process of being implemented by the identified organization in the industry group in comparison to the set of the ECM solutions associated with the respective industry group.

In the example interface 1000, the quantitative indicators are bar graphs that are displayed in the background of each of the organization segment fields 1020A-K, and the organization sub-segment fields of the sets of organization sub-segment fields 1030A-K. The industry group quantitative indicator has a bar graph set aside from the title of the industry group field 1016. A shaded bar graphical representation is only seen in the cells where the organization has implemented one or more of the available ECM solutions that are associated with the cell. The lack of a shaded bar graphical representation indicates that no ECM solutions have been implemented in that organization segment or sub-segment.

In alternative examples the quantitative indicator may be a numeric percentage or ratio, or a graphical representation other than a bar graph, such as, for example, a pie chart, or a Venn diagram. Also in an example, the quantitative indicator is not present in one or more of the fields, such as the industry group field 1016, and/or the sets of organization sub-segment fields 1030A-K.

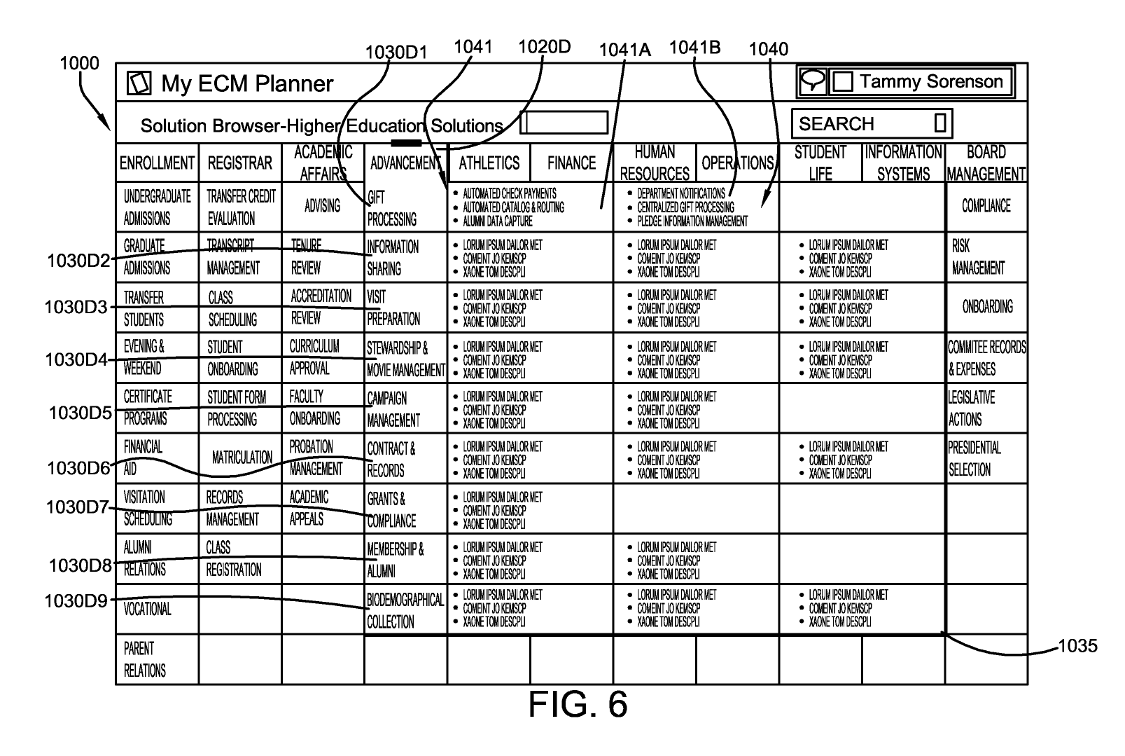

FIG. 6 depicts an example graphical user interface 1000 that results from the transmission of display data and an electronic request (such as a “click”) by the user to obtain further information on an organization segment, such as, in this case, the “Advancement” organization segment field 1020D of FIG. 5. It is also another example of a graphical representation of the display data that includes format data and information from an example first template as discussed above.

In FIG. 6 the organization segment field 1020D for the Advancement Segment of a higher education organization is shown in an expanded view, whereas the remainder of the organization segment fields 1020A-C, 1020E-K in the graphical user interface 1000 are grayed out. In this context, “grayed out” means displayed at a lower color and/or black level, such as a 1% to 99%, 10% to 75%, or 25% to 50%.

In example graphical user interface 1000 of FIG. 6, the Advancement organization segment field 1020D expands to the side of the column that has the most display area. In this case the right side. This expanded section 1035 includes a set of ECM solution fields 1040, with each row containing one to three cells, listing titles of the individual ECM solutions associated with the sub-segment in the organization sub-segment fields 1030D1-1030D9.

For example, in a first ECM solution field 1041 associated with the Gift Processing 1030D1 organization sub-segment field, six individual ECM solution titles are listed in cells 1041A and 1041B. In this example, none of the solutions have been implemented by the organization because the quantitative indicators are all showing zero filling in the bar graph. Thus, in this case, all the ECM solutions listed are those that are available, but not implemented. In an example where ECM solutions had been implemented, the ECM solution titles that are implemented or are being implemented may be highlighted or otherwise indicated.

In this example all the ECM solutions associated with the Advancement organization segment 1020D are listed in the expanded section. In another example, the user's electronic request (such as a “click”) is located on an organization sub-segment field 1030D1-1030D9. In an example, clicking on the organization sub-segment field 1030D1 results in the display of only the ECM solution cells 1041A, 1041B associated with the Gift Processing organization sub-segment 1030D1 in a row extending therefrom. In this example, ECM solution fields for the other organization sub-segments 1030D1-1030D9 in the Advancement organization segment field 1020D are not displayed, but the underlying “grayed out” cells are instead.

FIG. 7 depicts an example graphical user interface 1000 with an ECM solution detailed information window 1100. In this example of the graphical user interface 1000, clicking or otherwise indicating through interaction with the GUI, the organization sub-segment field 1030, in this case, the “Student Onboarding” 1030B4 organization sub-segment field, results in the ECM solution detailed information window 1100 being displayed.

The ECM solution detailed information window 1100 corresponding to the “Student Onboarding” organization sub-segment field 1030B4 includes a set of ECM solution fields 1110. A first example ECM solution field 1110A displays a title of the ECM solution and further details describing the ECM solution.

In an example, additional features may be triggered by clicking or otherwise indicating through interacting with the GUI 1000 the first ECM solution field 1110A. For example an animation showing the ECM solution field 1110A flipping over like a card, may occur displaying one or more of a further description of the ECM solution, a feedback entry text box to provide feedback information on the ECM solution, information on a cost estimate for implementation of the ECM solution, an estimate on the time to implement the ECM solution, a flat fee price, an interactive link to initiate an electronic request to the ECM provider to implement one of the set of enterprise content management solutions, and an interactive link to initiate an electronic request to the ECM provider provide a customized time or cost quote for the implementation of the ECM solutions.

In an example, each of the ECM solution fields 1110 has a graphical indicator, indicating whether the organization has implemented or is in the process of implementing the solution or neither.

The example ECM solution detailed information window 1100 also displays an ECM solution save field 1150 where an ECM solution field 1110 can be dragged or otherwise indicated to be associated with this field 1150. A user may use this ECM solution save field 1150 to save one or more ECM solutions for printing, saving, or exporting a report, for obtaining a combined scheduling or cost quote, or for further operations within the tool. This field allows multiple ECM solutions to be saved and processed for further research, discussion with others, or requesting implementation.

In another example the ECM solution save field 1150 is displayed on the main ECM solution graphical user interface 1000.

All “fields” in the example graphical user interface 1000 are interactive fields, meaning that an electronic selection or input within the field will produce a further display item or enter information.

In an example, when one or more new ECM solutions are added to an industry template or templates, whether the solution was initiated by the ECM provider or proposed by a user, a notification is generated by the processor and transmitted as display data to organizations that are identified as associated with the affected template or templates. The notification may, for example, be in the form of an alert at the log-screen, or an icon or coloring change on the screen that displays the titles of the ECM segments and sub-segments (such as the graphical user interface 1000 shown in FIGS. 5 and 6 and/or on the ECM solution detailed information window 1100 shown in FIG. 7. Other notification methods may also be used. In an example, the notification is visually associated with the ECM segment and/or sub-segment that includes the newly added solution, as well as the new solution itself.

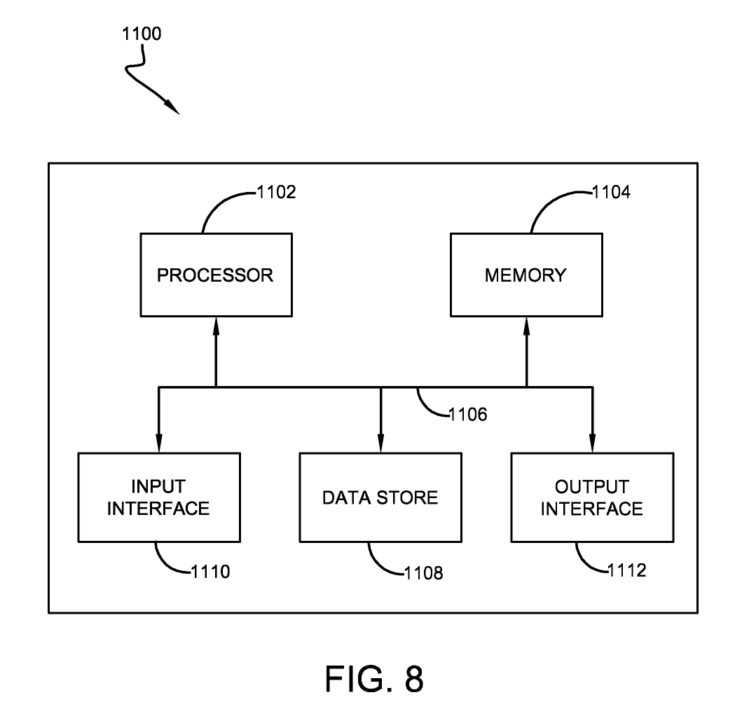

Referring now to FIG. 8, an illustration of an exemplary computing device 1100 that can be used in accordance with the ECM tool, GUI, and method disclosed herein is illustrated. The computing device can be implemented as part of the method or system by the ECM provider to input various template or ECM-related information, maintain or modify the ECM tool, or communicate with the organization users of the ECM tool. The computing device 1100 can also be implemented as part of the method or system by the organization user in viewing the display data as the graphical user interface. In an example a computing device 1100 can include at least the data storage 110 and processor 120 components of FIG. 1. In an example, FIG. 8 is an example of a computing device 145 of FIG. 1.

The computing device 1100 includes data storage 1108 that is accessible by the processor 1102 by way of the system bus 1106. The data storage 1108 may include executable instructions to operate the processor 1102 and other components. The computing device 1100 also includes an input interface 1110 that allows external devices to communicate with the computing device 1100. For instance, the input interface 1110 may be used to receive instructions from an external computer device, from a user, etc. The computing device 1100 also includes an output interface 1112 that interfaces the computing device 1100 with one or more external devices. For example, the computing device 1100 may display text, images, etc. by way of the output interface 1112.

It is contemplated that the external devices that communicate with the computing device 1100 via the input interface 1110 and the output interface 1112 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1100 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1100 may be a distributed system. Thus, for instance, several devices may be in communication by way of a network connection and may collectively perform tasks described as being performed by the computing device 1100.

As used herein, the terms “tool” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and BLU-RAY (BD), where disks usually reproduce data magnetically and discs usually reproduce data optically with lasers. Further, in an example, a propagated signal is not included within the scope of computer-readable storage media or display data. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

1-14. (canceled)

15. A computer-implemented method comprising:
receiving organization identifier input;
identifying an organization from the organization identifier input and producing an identified organization;
determining a first template associated with the identified organization from a set of templates,
the first template comprising a set of organization segments, a set of organization sub-segments, or both, and a set of enterprise content management solutions associated with an industry group and available for implementation;
determining enterprise content management organization information associated with the identified organization, the enterprise content management organization information comprising enterprise content management implementation information that is a set of enterprise content management solutions already implemented or in the process of being implemented by the identified organization;
generating, by a processor, a quantitative indicator based on the set of the enterprise content management solutions and the enterprise content management implementation information, the quantitative indicator indicating a total number of enterprise content management solutions in the set of enterprise content management solutions already implemented or in the process of being implemented by the identified organization in the industry group, the organization segment, or the organization sub-segment, in comparison to a total number of enterprise content management solutions in the set of the enterprise content management solutions available for implementation in the respective industry group, organization segment, or the organization sub-segment; and
transmitting display data for displaying the set of organization segments, organization sub-segments, or both, the set of enterprise content management solutions, and the quantitative indicator.

16. The computer-implemented method of claim 15, further comprising
receiving enterprise content management solution feedback information from an organization that implements an enterprise content management solution, the enterprise content management solution feedback information comprising one or more of feedback comments on a first enterprise content management solution, and electronic contact information for the organization that implements the first enterprise content management solution; and
transmitting display data comprising the enterprise content management solution feedback information.

17. The computer-implemented method of claim 16, wherein the enterprise content management solution feedback information includes privacy data indicating a set of organizations that the organization providing enterprise content management collaborative information is willing or unwilling to share the feedback information with.

18. The computer-implemented method of claim 15, wherein the display data includes a user-interactive link to initiate an electronic request to implement one of the set of enterprise content management solutions, to initiate an electronic request to provide a customized time or cost quote for the implementation of one of the set of the enterprise content management solutions, or both.

19. The computer-implemented method of claim 15, further comprising receiving an electronic request for enterprise content management solution detailed information, the enterprise content management solution detailed information including information on a cost estimate for implementation of a first solution, an estimate on the time to implement the first solution, or both; and transmitting display data comprising the enterprise content management solution detailed information.

20. The computer-implemented method of claim 15, further comprising modifying the template based on the organization identifier and enterprise content management organization information stored in computer-implemented data storage associated with the organization identifier, the enterprise content management organization information comprising one or more of: a number of employees of the organization, revenue amount, revenue ranking, industry operations of the organization, privacy data, server or database infrastructure information, or information on organization information technology personnel.

21. (canceled)

22. The computer-implemented method of claim 15, further comprising: associating a new enterprise content management solution with the set of enterprise content management solutions that are associated with the industry group, and transmitting display data comprising a notification of the new enterprise content management solution.

23. The computer-implemented method of claim 15, wherein the quantitative indicator indicates the comparison in a form of a ratio.

24. The computer-implemented method of claim 15, wherein the quantitative indicator indicates a total number of enterprise content management solutions in the set of enterprise content management solutions already implemented or in the process of being implemented by the identified organization in the organization segment in comparison to a total number of enterprise content management solutions in the set of the enterprise content management solutions available for implementation in the respective organization segment.

25. The computer-implemented method of claim 24, wherein the display data includes format data indicating that the quantitative indicator is displayed in proximity to a segment title or in the background of a display cell or field showing the segment title.

26. The computer-implemented method of claim 15, wherein the quantitative indicator indicates a total number of enterprise content management solutions in the set of enterprise content management solutions already implemented or in the process of being implemented by the identified organization in the organization sub-segment in comparison to a total number of enterprise content management solutions in the set of the enterprise content management solutions available for implementation in the respective organization sub-segment.

27. The computer-implemented method of claim 26, wherein the display data includes format data indicating that the quantitative indicator is displayed in proximity to a sub-segment title or in the background of a display cell or field showing the sub-segment title.

28. The computer-implemented method of claim 15, wherein the display data includes an option for electronically submitting feedback for one or more enterprise content management solutions.

29. The computer-implemented method of claim 28, wherein the display data is customized based on the organization identifier to only allow a user to provide feedback on enterprise content management solutions they that have implemented and/or are implementing.

30. The computer-implemented method of claim 28, wherein the option for electronically submitting feedback further comprises an option to restrict contact information that is presented to specified organizations in an industry.

31. The computer-implemented method of claim 15, wherein the total number in the set of the enterprise content management solutions available for implementation by the respective industry group is greater than 1.

32. The computer-implemented method of claim 15, wherein the quantitative indicator is a plurality of quantitative indicators that indicate a total number of enterprise content management solutions in the set of enterprise content management solutions already implemented or in the process of being implemented by the identified organization in each organization segment and each organization sub-segment, in comparison to a total number of enterprise content management solutions in the set of the enterprise content management solutions available for implementation in each respective organization segment and each respective organization sub-segment; and
transmitting display data for displaying the set of organization segments, organization sub-segments, or both, the set of enterprise content management solutions, and the plurality of quantitative indicators.

33. A computer-implemented method comprising:
receiving an organization identifier input;
identifying an organization from the organization identifier input and producing an identified organization, wherein the identified organization is included in a group comprising of at least one other organization;
identifying, for the identified organization, a number of enterprise content management solutions implemented or in the process of being implemented by the identified organization;
identifying, for the identified organization, a number of enterprise content management solutions available to be implemented by the identified organization;
determining a ratio of the number of enterprise content management solutions implemented by the identified organization to the number of enterprise content management solutions available to be implemented by the identified organization, wherein the ratio indicates a degree of utilization of enterprise content management solutions by the identified organization;
obtaining an average of utilization of enterprise content management solutions for the at least one other organization in the group, wherein the average is generated based upon the total number of enterprise content management solutions utilized by each organization in the group divided by the number of organizations in the group;
comparing the ratio obtained for the organization with the average of utilization of enterprise content management solutions for the at least one other organization in the group; and
determining whether the ratio obtained for the organization is greater than or less than the average utilization of enterprise content management solutions for the group.

34. The computer-implemented method of claim 33, further comprising displaying the ratio obtained for the organization in conjunction with the average utilization of enterprise content management solutions for the group.

35. The computer-implemented method of claim 33, wherein the group is an industry group comprising one or more organization segments and/or one or more organization sub-segments.
